(19) United States
(12) Patent Application Publication
(10) Pub. No.: US 2013/0167049 A1
(43) Pub. Date: Jun. 27, 2013

(54) GEOGRAPHIC INFORMATION SERVICE SYSTEM

(71) Applicant: LG CNS CO., LTD., Seoul (KR)

(72) Inventors: Jae-Pil Seo, Seoul (KR); Soo-Hyun Shin, Seoul (KR)

(73) Assignee: LG CNS CO., LTD., Seoul (KR)

(21) Appl. No.: 13/717,779

(22) Filed: Dec. 18, 2012

(30) Foreign Application Priority Data
Dec. 27, 2011 (KR) 10-2011-0143183
Mar. 2, 2012 (KR) 10-2012-0021904

(51) Int. Cl. G06F 9/44

(52) U.S. Cl. CPC G06F 8/38
USPC 715/762

(57) ABSTRACT

In general, embodiments of the present invention relate to a geographic information system (GIS) and methods for developing a GIS web service. More particularly, the present invention relates to developing a GIS web service for monitoring and/or controlling a plurality of building functions relating to various utility, security, maintenance, etc., systems within a single building and/or a plurality of buildings.

### CROSS-REFERENCE TO RELATED APPLICATION

This application claims priority under 35 U.S.C §119 to Korean Patent Application No. 10-2011-0143183, filed on Dec. 27, 2011, and Korean Patent Application No. 10-2012-0021904 filed on Mar. 2, 2012 in the Korean Intellectual Property Office, the contents of which is incorporated herein by reference.

### TECHNICAL FIELD

In general, embodiments of the present invention relate to a geographic information system (GIS). Specifically, embodiments of the present invention relate to a system and method for developing a GIS web service for facility management.

### BACKGROUND OF THE INVENTION

A geographic information system (GIS) integrates hardware, software, and data for capturing, managing, analyzing, and displaying all forms of geographically referenced information. GIS allows users to view, understand, question, interpret, and visualize data in many ways that reveal relationships, patterns, and trends in the form of maps, globes, reports, and charts. A GIS helps answer questions and solve problems by looking at the data in a way that is quickly understood and easily shared. GIS technology may be integrated into virtually any type of enterprise information system framework.

Technically, GIS is a geographic information system which includes mapping software and its application with remote sensing, land surveying, aerial photography, mathematics, photogrammetry, geography, and tools that can be implemented with GIS software. Still, many refer to a “geographic information system” as GIS even though it doesn't cover all tools connected to topology. In the strictest sense, a GIS system describes any information system that integrates, stores, edits, analyzes, shares, and displays geographic information. In a more generic sense, GIS applications are tools that allow users to create interactive queries (user created searches), analyze spatial information, edit data and maps, and present the results of all these operations.

U.S. Patent Application 20080065658 provides a method for developing the GIS web service framework which is developed using a database that stores spatial data to provide an access for a GIS web service.

U.S. Pat. No. 7,742,901 discloses a method and system for analyzing and/or generating object models and, in particular, to generating object models of a second type using object models of the first type.

U.S. Patent Application 20070273711 discloses a unique 3D graphics system and method that allows participants to change their avatar's clothes by constructing a new avatar consisting of multiple models including the basic nude model and all of its parts, all the clothing models, hair models, and any other models that might be required.

U.S. Patent Application 20050137015 discloses a system and method for that allows for a role-playing game having a customizable avatar and differentiated instant message environment.

U.S. Patent Application 20110270833 discloses a method, system, and program for providing access to spatial data in which a request for data is received, enterprise and third party data are integrated, integrated data is processed, spatially referenced results are generated using the processed data, and the spatially referenced results are returned in response to the request.

There is a need for inter-system scalability and improved ease of development in creating a GIS web service. Therefore, what is needed is a solution that addresses at least one of the deficiencies of the current art.

### SUMMARY

The present invention provides an approach in which a plurality of sensors observe or sense conditions and/or statuses of different facilities. The sensors generate service data which transmitted from a facility management server to a GIS client device. The GIS client device also receives geospatial information from various GIS servers having different protocols. A GIS application on the GIS client device contains an application programming interface (API) that produces a plurality of files (e.g., JavaScript files) from the data received. Each file is associated with an object to be represented on a map. Each file is composed of component modules. Using a web service development engine on the GIS client device, one or more of the component modules may be modified, added, or deleted. The modified component modules are viewed along with the service data as a web service in a single interface.

A first aspect of the present invention provides a computer-implemented method for developing a geographic information system (GIS) web service, comprising: receiving service data associated with a facility; receiving geospatial information, wherein the geospatial information includes the location of the facility; producing an object from the geospatial information, the geospatial information comprising a plurality of components; modifying at least one of the plurality of components; and generating a single interface based on the service data and the plurality of components.

A second aspect of the present invention provides a client device for developing a geographic information system (GIS) web service, comprising: a viewer module configured to receive service data associated with a facility; an application module configured to receive geospatial information, wherein the geospatial information includes the location of the facility; the application module further configured to produce an object from the geospatial information, the geospatial information comprising a plurality of components; a web service development engine configured to modify at least one of the plurality of components; and the viewer module further configured to generate a single interface based on the service data and the plurality of components.

A third aspect of the present invention provides a computer program product for developing a geographic information system (GIS) web service, the computer program product comprising a computer readable storage medium, and program instructions stored on the computer readable storage medium, to: receive service data associated with a facility; receive geospatial information, wherein the geospatial information includes the location of the facility; produce an object from the geospatial information, the geospatial information comprising a plurality of components; modify at least one of the plurality of components; and generate a single interface based on the service data and the plurality of components.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an example computing node according to an embodiment of the present invention.

FIG. 2 depicts an example geographic information service system (GIS) diagram according to an embodiment of the present invention.

FIG. 3 depicts an example GIS application diagram according to an embodiment of the present invention.

FIG. 4 depicts an example GIS viewer structure diagram according to an embodiment of the present invention.

FIG. 5 depicts an example method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As used herein, the terms “component,” “module,” “engine,” and “system” are intended to refer to a computer-related entity, either hardware, a combination of hardware and software, software, or software in execution. For example, a component can be, but is not limited to being, a process running on a processor, a processor, an object, an executable program/instructions, a thread of execution, a program, and/or a computer. By way of illustration, both an application running on a server and the server can be a component. One or more components can reside within a process and/or thread of execution, and a component can be localized on one computer and/or distributed between two or more computers.

In general, embodiments of the present invention relate to a geographic information system (GIS) and methods for developing a GIS web service. More particularly, the present invention relates to developing a GIS web service for monitoring and/or controlling a plurality of building functions relating to various utility, security, maintenance, etc., systems within a single building and/or a plurality of buildings.

In an exemplary embodiment, a plurality of sensors observe or sense conditions and/or statuses of different facilities. The sensors generate service data which transmitted from a facility management server to a GIS client device. The GIS client device also receives geospatial information from various GIS servers having different protocols. A GIS application on the GIS client device contains an application programming interface (API) that produces a plurality of files (e.g., JavaScript files) from the data received. Each file is associated with an object to be represented on a map. Each file is composed of component modules. Using a web service development engine on the GIS client device, one or more of the component modules may be modified, added, or deleted. The modified component modules are viewed along with the service data as a web service in a single interface.

A web service is a method of communication between two electronic devices over the Web (Internet). The web service creates a platform independent distribution channel for GIS data, without it being apparent that data has come from different sources or locations. Web services are a convenient way to access GIS data over the Internet. The systems and methods of the present invention will be described below in greater detail.

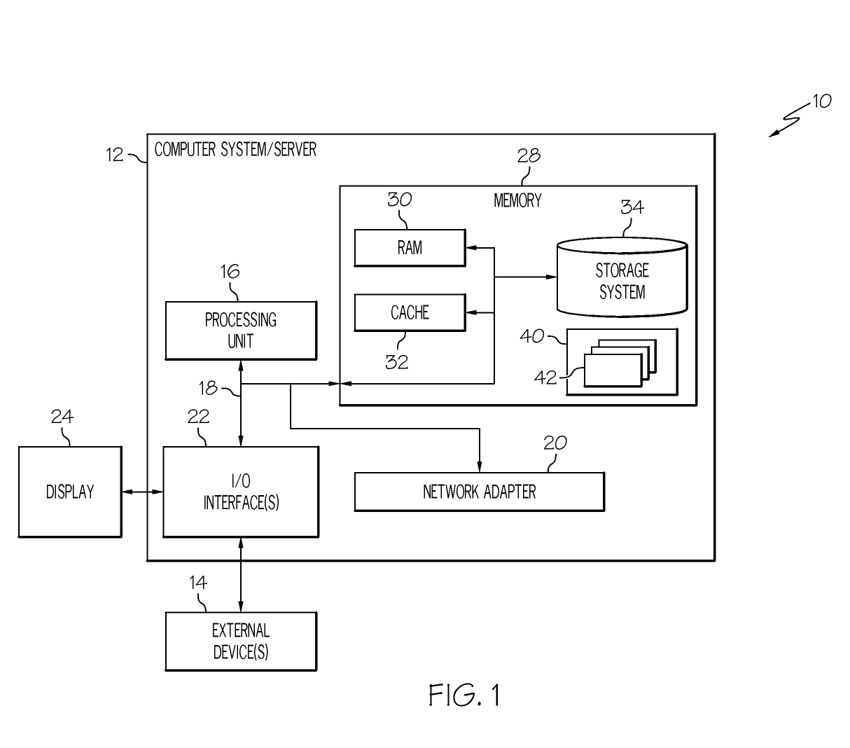

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Web service development engine 115, having a set (at least one) of program modules 42, may be stored in memory 28 by way of example, and not limitation, as well as an operating system, one or more application programs, other program modules, and program data. In general, web service development 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is understood that the teachings recited herein may be practiced within any type of networked computing environment (e.g., a cloud computing environment). A computer system/server 12 can be implemented as either a stand-alone computer system or as a networked computer system. In the event the teachings recited herein are practiced in a networked computing environment, each client need not have a web service development engine 115. Rather, web service development engine 115 could be loaded on a server (e.g., web services server) or server-capable device that communicates (e.g., wirelessly) with the clients to provide web service development functionality hereunder. Regardless, as depicted, web service development engine 115 is shown within computer system/server 12. In general, web service development engine 115 can be implemented as engine 115 on computer system 12 of FIG. 1 and can enable the functions recited herein. As further shown, web service development engine 115 (in one embodiment) comprises a rules and/or computational engine that processes a set (at least one) of rules/logic and/or provides web service development functionality hereunder.

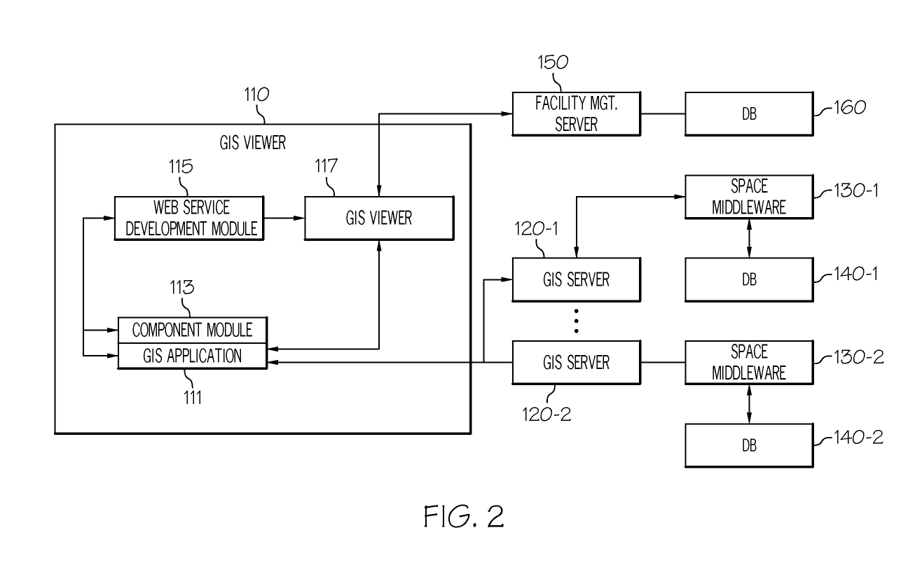

FIG. 2 depicts an example geographic information service system (GIS) diagram according to an embodiment of the present invention. As shown, the GIS includes GIS client device 110, GIS server 120-1, GIS server 120-2, and facility management server 150. In operation, the GIS may include any number of GIS clients and GIS servers. GIS server 120-1 accesses database (DB) 140-1. Database requests from GIS server 120-1 are sent to DB 140-1 via space middleware 130-1. Similarly, GIS server 120-2 accesses database (DB) 140-2 using space middleware 130-2. Data can be stored in databases with different storage schema. In a typical embodiment, databases 140-1 and 140-2 are relational databases. A relational database stores data in tables, which is a collection of relations, with schema that identifies relationships between columns and rows and various tables.

GIS client device 110 may include any device such as a smart phone, cell phone, personal digital assistant (PDA), laptop, personal computer (PC) or the like, that is operable within a communications network. The communications network may comprise or form part of a network, such as a WiMAX network, a broadband wireless access (BWA) network, a WLAN, a WMAN, a wireless wide area network (WWAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The facility management server 150 accesses database (DB) 160. The facility management server 150 may manage one or more operations of a facility. Through a communications network, such as the Internet, the facility management server 150 is in communication with one or more sensors. The sensors are located at or in one or more facilities. In one example, a facility may include a structure or building including, but not limited to, a multi-unit apartment building or complex, a multi-unit condominium building or complex, a house, residential housing, a dormitory, a hospital, a long- or short-term healthcare facility, a train station, a sports stadium, a concert hall or an entertainment hall. In another example, a facility may include a parcel of real estate where people gather to participate in an event including, but not limited to, an indoor or outdoor carnival, public park, or amusement park.

In operation, the sensors observe or sense a plurality of variable conditions and/or statuses of the facility, and the sensors generate service data. For example, service data may include information related to street lighting, underground water pipe transportation, and tributary pollution. The facility management server 150 receives the service data from the sensors and stores the service data in the database 160. Along with facility status information, attribute information related to the managed facility may also be stored in database 160, such as installation date, equipment serial numbers, logs, and the like.

The facility management server 150 communicates with a GIS viewer 117 of the GIS client device 110. Service data received at the facility management server 150 may be presented at the GIS viewer 117. Generally, GIS viewer 117 may be a viewer application, such as a web browser or equivalent. For example, the viewer application may be embodied as a plug-in for use with Internet Explorer 7 which is commercially available from Microsoft of Redmond, Wash. GS viewer 117 may be presented on any appropriate display screen. The display screen may be a liquid crystal display (LCD), light-emitting diode (LED), plasma, projection, cathode ray tube (CRT), or any other appropriate illumination screen.

The GIS includes one or more GIS servers, such as GIS server 120-1 and GIS server 120-2. GIS servers 120-1 and 120-2 may have access to databases resident on its servers or also may access external databases over a network, such as the Internet. These databases may include civic, private, or research data bases such as Landsat data, aerial photographs, geologic maps, and the like. The servers may be configured to interpret a wide variety of data available on the Internet and import and format the data such that the data may be used as a layer in a GIS. The data stored in one or more of the databases may be associated with one or more facilities being managed by the facility management server 150.

Each GIS server 120-1 and 120-2 is configured to exchange and share data (e.g., provide geographic/spatial data) with GIS client device 110. Several geospatial web services are based on the specifications developed by the Open Geospatial Consortium (OGC), such as WMS (web map service), WFS (web feature service) and WCS (web catalog service). The development process of these specifications has been parallel to the standard web services development. WMS is mainly for sharing and transforming spatial data in image formats, such as .jpg and .gif. WFS is mainly for sharing and transforming vector data in XML formats, such as GML, and WCS allows for the exchange of interpreted or extrapolated data, rather than data portrayed in vector or raster formats. Selection of appropriate specifications depends on what content is communicated between components.

GIS client device 110 includes GIS application 111, component modules 113, web services development module 115, and GIS viewer 117. The web service development module 115 may interact with one or more component modules 113 provided by application component 111 to provide the capability for developing a GIS-related web service. For example, web services related to street lighting control, constant underground conduit management, transportation information management, tributary contamination control, and the like may be developed.

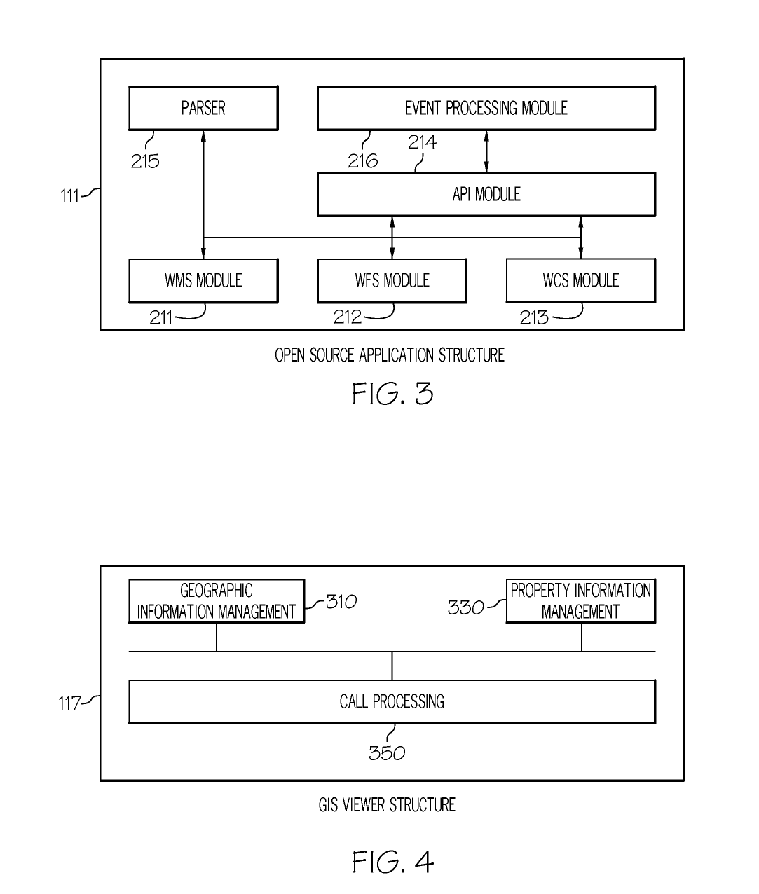

FIG. 3 depicts an example GIS application diagram in greater detail according to an embodiment of the present invention. As shown in FIG. 4, GIS application 111 is an open source application structure which includes WMS module 211, WFS module 212, WCS module 213, application program interface (API) module 214, parser 215, and event processing module 216.

GIS application 111 is an open source JavaScript library for displaying map data in web browsers. It provides application programming interface (API) module 214 for building rich web-based geographic applications. GIS application 111 allows a developer to obtain data from a variety of geospatial data sources or services provided by the GIS servers 120-1 and 120-2. According to various embodiments, GIS application 111 provides a way to interact with WMS module 211, WFS module 212, and WCS module 213. GIS application 111 provides parser 215 to deal with the complexities of geospatial information. GIS application 111 can be expanded to support additional data formats with the simple addition of components or modules into GIS application 111.

The event processing module 216 provides output to the API module 214 based on a user event For example, the user may move the map, perform an address search, edit an address, or enter a point of interest. The API module 214 may map the information provided by the event processing module 216 with the geographical information to express in on the GIS Viewer 117. In one example, geographic markup language (GML) may be used to express geographical features on the GIS viewer 117. The GML is a modeling language for geographic systems as well as an open interchange format for geographic transactions.

GML is a simple text-based encoding of geographic features. GML is based on a common model of geography (OGC Abstract Specification) which has been developed and agreed to by the vast majority of all GIS vendors in the world. More importantly, however, GML is based on XML. XML is easy to transform. Using Extensible Stylesheet Language Transformations (XSLT) or almost any other programming language (VB, VBScript, Java, C++, Javascript) XML can be transformed from one form to another. A single mechanism can thus be employed for a host of transformations from data visualization to coordinate transforms, spatial queries, and geo-spatial generalization. Since GML rests on the widely adopted public standard of XML, this ensures that GML data can be viewed, edited and transformed.

Referring back to FIG. 2, one or more component modules 113 are provided by GIS application 111. The component modules 113 may adhere to Open Geospatial Consortium (OGC) specifications. The component modules 113 may provide an object including location specific mapping information related to an item (e.g., road, building, river, etc.) to be displayed on a map and the associated coding functions.

Objects are descriptions of the way that map features should be rendered. Each object is made up of one JavaScript (.js) with each JavaScript file containing any number of component modules. A web services developer may modify, add, or delete one or more of these component module parameters. A component may be associated with a map search, map edit, map layer display, map layer control, location search, or map event.

The component modules 113 may include the definition of the basic parameters of the summary views, forms, maps, and dynamic data defining how each will be displayed in a graphical format to the end user utilizing GIS client device 110. These parameters control properties of the displayed data such as the size and placement of view, form, or map windows. Another function supports the operation of the various interactive elements of the view, form, and map windows. These interactive elements may include, but are not limited to, user-selectable buttons which allow the user to navigate through (i.e., request views of) the client subsystem-displayed forms and views (including map views comprised of dynamic data overlaid on static map images), user-selectable buttons which allow the submission, modification, and cancellation of forms, and user-selectable map display tools which allow users to pan, scroll, and zoom a static map displayed on the GIS viewer 117 of GIS client device 110.

The modified component modules are viewed using the GIS viewer along with the service data received by GIS client device 110 as a web service using GIS viewer 117 in a single interface. FIG. 4 depicts an example structure diagram for GIS viewer 117 according to an embodiment of the present invention. As shown, GIS viewer 117 includes geographic information management 310, property information management 330, and call processing 350.

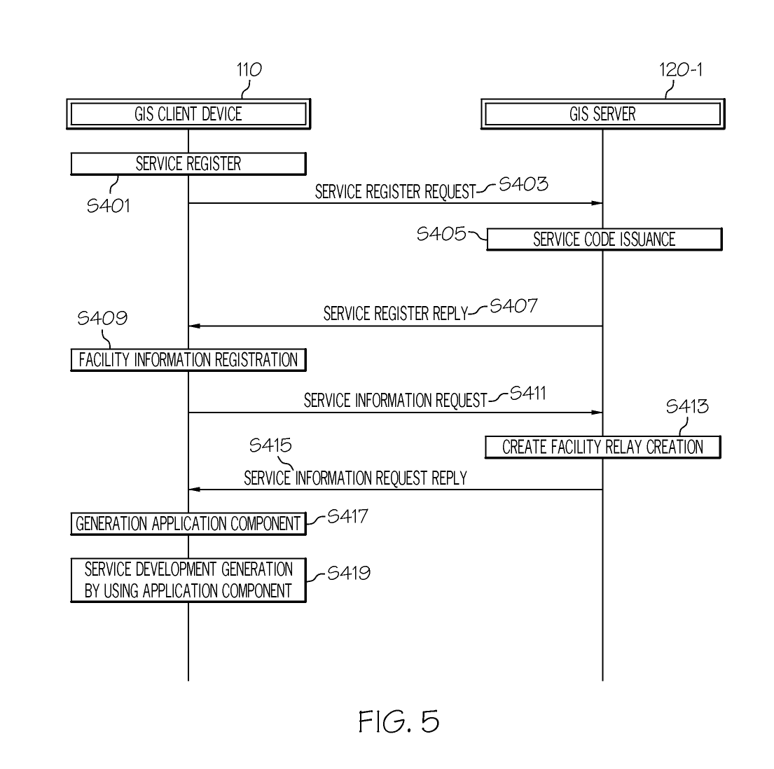

Referring now to FIG. 5, an example method flow diagram according to an embodiment of the present invention is shown (e.g., as enabled by GIS web service web service development engine 115). A GIS developer wanting to develop a GIS client device 110 may register one or more services with a GIS server (e.g., GIS server 120-1). Services may include, for example, street lighting control service, underground water pipe management services, motor vehicle transportation information management services, and tributary pollution control services. The services listed are examples and not intended to be limited. Any appropriate service relating to the monitoring and/or management of a facility may be registered. At S401, a service register request is generated at GIS client device 110. At S403, the service register request is transmitted to GIS server 120-1. At S405, the requested service is issued a service code. At S407, the service code, which includes the registration response, is sent to the GIS client device 110 where it is received.

Geographical information associated with a service facility may be registered using a facility information request. At S409, a service information request is generated. Geographic information of a facility may include the facility's geographical position coordinates, a facility identification number (ID), an icon to represent the facility on a map, style information, and the like. At S411, the service information request is sent to the GIS servers 120-1 and 120-2. At S413, the facility is created using the geographical information provided. The data associated with the facility is stored in databases 140-1 and 140-2. At S415, a service information request reply is sent to the GIS client device 110

While shown and described herein as a GIS web service development solution, it is understood that the invention further provides various alternative embodiments. For example, in one embodiment, the invention provides a computer-readable/useable medium that includes computer program code to enable a computer infrastructure to provide GIS web service development as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide GIS web service development functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for GIS web service development. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for developing a geographic information system (GIS) web service, comprising:
receiving service data associated with a facility;
receiving geospatial information, wherein the geospatial information includes the location of the facility;
producing an object from the geospatial information, the geospatial information comprising a plurality of components;
modifying at least one of the plurality of components; and
generating a single interface based on the service data and the plurality of components.

2. The computer-implemented method of claim 1, further comprising:
sensing a status of a facility; and
generating service data based on the status of the facility.

3. The computer-implemented method of claim 1, wherein the object is a JavaScript file.

4. The computer-implemented method of claim 1, wherein the service data is associated with at least one of street lighting, underground water pipe transportation, tributary pollution, or motor vehicle transportation.

5. The computer-implemented method of claim 1, wherein at least one of the plurality of components is associated with a map search, map edit, map layer display, map layer control, location search, or map event.

6. The method of claim 1, wherein the single interface is generated using a viewer application.

7. The method of claim 1, wherein the single interface is displayed on a display screen.

8. A client device for developing a geographic information system (GIS) web service, comprising:
a viewer module configured to receive service data associated with a facility;
an application module configured to receive geospatial information, wherein the geospatial information includes the location of the facility;
the application module further configured to produce an object from the geospatial information, the geospatial information comprising a plurality of components;
a web service development engine configured to modify at least one of the plurality of components; and
the viewer module further configured to generate a single interface based on the service data and the plurality of components.

9. The client device of claim 8, wherein the service data is associated with sensing data produced from at least one sensor of a facility.

10. The client device of claim 8, wherein the object is a JavaScript file.

11. The client device of claim 8, wherein the service data is associated with at least one of street lighting, underground water pipe transportation, tributary pollution, or motor vehicle transportation.

12. The client device of claim 8, wherein at least one of the plurality of components is associated with a map search, map edit, map layer display, map layer control, location search, or map event.

13. The client device of claim 8, wherein the single interface is displayed on a display screen.

14. The client device of claim 8, wherein the client device is one of a smart phone, cell phone, personal digital assistant (PDA), laptop, or personal computer (PC).

15. A computer program product for developing a geographic information system (GIS) web service, the computer program product comprising a computer readable storage medium, and program instructions stored on the computer readable storage medium, to:
receive service data associated with a facility;
receive geospatial information, wherein the geospatial information includes the location of the facility;
produce an object from the geospatial information, the geospatial information comprising a plurality of components;
modify at least one of the plurality of components; and
generate a single interface based on the service data and the plurality of components.

16. The computer program product of claim 15, wherein the service data is associated with sensing data produced from at least one sensor of a facility.

17. The computer program product of claim 15, wherein the object is a JavaScript file.

18. The computer program product of claim 15, wherein the service data is associated with at least one of street lighting, underground water pipe transportation, and tributary pollution, or motor vehicle transportation.

19. The computer program product of claim 15, wherein the single interface is generated using a viewer application.

20. The computer program product of claim 15, the computer readable storage medium further comprising instructions to display the single interface on a display screen.
